(19) United States
(12) Patent Application Publication
(10) Pub. No.: US 2014/0165181 A1
(43) Pub. Date: Jun. 12, 2014

(54) NETWORK APPARATUS AND OPERATING METHOD THEREOF

(71) Applicant: ELECTRONICS AND TELECOMMUNICATIONS RESEARCH INSTITUTE, Daejeon (KR)

(72) Inventors: Pyung Koo PARK, Daejeon (KR); Sung Back HONG, Daejeon (KR); Ho Yong RYU, Daejeon (KR)

(73) Assignee: ELECTRONICS AND TELECOMMUNICATIONS RESEARCH INSTITUTE, Daejeon (KR)

(21) Appl. No.: 13/973,400

(22) Filed: Aug. 22, 2013

(30) Foreign Application Priority Data
Dec. 10, 2012 (KR) 10-2012-0142815

(51) Int. Cl. H04L 29/06

(52) U.S. Cl. CPC H04L 63/02; H04L 63/1458
USPC 726/11

(57) ABSTRACT

Disclosed are a network apparatus and an operating method thereof. The network apparatus includes: a security authentication module that executes security authentication of a distributed denial of service (DDoS) attack when a predetermined packet requests access to a particular service server to which the security authentication is applied, at the time of inputting the predetermined packet; and a communication module that transmits the predetermined packet security-authenticated by the security authentication module through a transmission route of the particular service server, so as to easily defend the DDoS attack by using a pseudo state of a service procedure.

### CROSS-REFERENCE TO RELATED APPLICATIONS

This application claims priority to and the benefit of Korean Patent Application No. 10-2012-0142815 filed in the Korean Intellectual Property Office on Dec. 10, 2012, the entire contents of which are incorporated herein by reference.

### TECHNICAL FIELD

Exemplary embodiments relate to a network apparatus and an operating method thereof, and more particularly, to a network apparatus that easily defends an attack of a distributed denial of service (DDoS) by using a pseudo state of a service procedure, and an operating method thereof.

### BACKGROUND ART

In recent years, as a high-speed Internet environment is constructed, damages by a network attack such as hacking or Internet invasion continuously occur. In particular, in the case of a large portal site, when a server is down or a problem such as a leakage of personal information occurs due to the network attack, an operator that operates the portal site may be extensively damaged.

A type of the network attack includes a distributed denial of service (DDoS) attack that induces a plurality of client computers to transmit a large quantity of packets all at once to a specific network system by infecting the plurality of client computers with a malignant code.

In the DDoS attack, since an attack method is simple and a tool for the DDoS attack can be easily acquired anywhere, even an elementary hacker can attack a network system by using the tool at various levels.

In recent years, since the DDoS attack is performed through a general packet, a study for defending the DDoS attack is in progress by distinguishing a correct packet and an abnormal.

### SUMMARY OF THE INVENTION

The exemplary embodiments of the present invention have been made in an effort to provide a network apparatus that easily defends an attack of a distributed denial of service (DDoS) by using a pseudo state of a service procedure, and an operating method thereof.

An exemplary embodiment of the present invention provides a network apparatus including: a security authentication module that executes security authentication of a distributed denial of service (DDoS) attack when a predetermined packet requests the access to a particular service server to which the security authentication is applied, at the time of inputting the predetermined packet; and a communication module that transmits the predetermined packet security-authenticated by the security authentication module through a transmission route of the particular service server.

Another exemplary embodiment of the present invention provides an operating method of a network apparatus, including: determining whether the access to a particular service server set based on 5 tuples included in a predetermined packet is requested at the time of inputting the predetermined packet; executing security authentication of a distributed denial of service (DDoS) attack when the access to the particular service server is requested; and transmitting the predetermined packet security-authenticated in the executing to the particular service server.

According to exemplary embodiments of the present invention, in a network apparatus and an operating method thereof, security authentication is executed at the time of requesting access to a predetermined packet input into a particular service server in which a frequency of a distributed denial of service (DDoS) attack is high, thereby reducing a network load and a load of security equipment.

The network apparatus and the operating method thereof can defend the distributed denial of service (DDoS) attack in accordance with a set defense algorithm when the predetermined packet is the DDoS attack.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a system diagram schematically illustrating a network system including a network apparatus according to an exemplary embodiment.

FIG. 2 is a control block diagram illustrating a control configuration of the network apparatus according to the exemplary embodiment of the present invention.

FIG. 3 is a diagram illustrating an entry field illustrating pseudo state information.

FIG. 4 is a flowchart illustrating an operating method of a network apparatus according to an exemplary embodiment of the present invention.

FIG. 5 is a flowchart for security authentication illustrated in FIG. 4.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, exemplary embodiments of the present invention will be described in detail with reference to the accompanying drawings.

In describing components of an exemplary embodiment, different reference numerals may refer to components of the same name depending on drawings and the same reference numeral may refer to the components of the same name in spite of different drawings. However, even in this case, corresponding components do not have different functions depending on the exemplary embodiments or the corresponding components do not have the same functions in different exemplary embodiments, and functions of the respective components will be determined based on a description of the respective components in the corresponding exemplary embodiment.

In describing the exemplary embodiment, when it is determined that the detailed description of the related known configuration or function to the present invention may obscure the gist of the present invention, the detailed description thereof will be omitted.

In describing the components of the exemplary embodiment, terms such as first, second, A, B, (a), (b), and the like may be used. The terms are used to just distinguish the component from other components and the essence, sequence, or order of the corresponding component is not limited by the terms. When it is disclosed that any component is “connected”, “coupled”, or “linked” to other components, it should be understood that the component may be directly connected or linked to other components, but another component may be “connected”, “coupled”, or “linked” between the respective components.

Hereinafter, a network apparatus and a method for sensing a distributed denial of service (DDoS) of the network apparatus according to exemplary embodiments of the present invention will be described below with reference to the accompanying drawings.

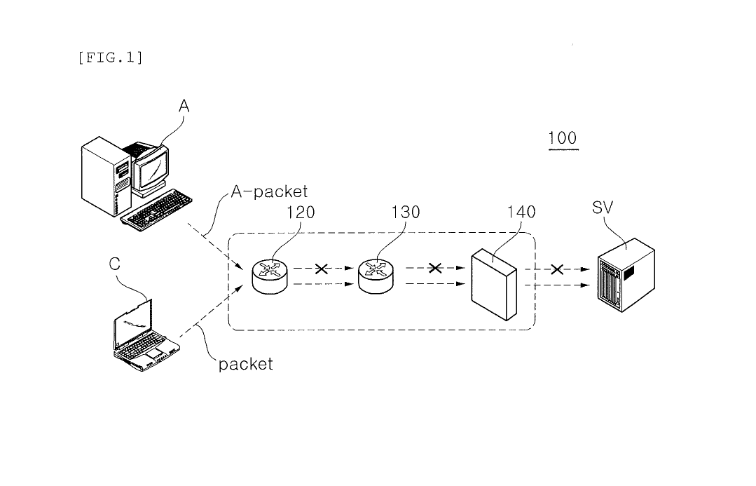

FIG. 1 is a system diagram schematically illustrating a network system including a network apparatus according to an exemplary embodiment.

Referring to FIG. 1, a network system 100 may include first and second terminal devices A and C, a network core NC, and a service server SV.

The system 100 is a very schematically illustrated system.

The first and second terminal devices A and C may collectively include all user terminals using an Internet protocol (IP), such as a mobile notebook, a portable terminal, and the like, in addition to a personal computer.

The first and second terminal devices A and C include an ATM series, an IP series, and the like depending on a characteristic of a line connected to the network core NC, or the like.

In the exemplary embodiment, the first terminal device A transmits an abnormal packet (A-packet) for a distributed denial of service (DDoS) attack and the second terminal device C transmits a correct packet in a correct state.

The network core NC may include first and second routers 120 and 130, and a security device 140, and the number of routers or security devices is not limited.

At least one of the first and second routers 120 and 130 may be a flow router and any one of the first and second routers 120 and 130 may be a routing router, and the present invention is not limited thereto.

In the exemplary embodiment, the first and second routers 120 and 130, which are the network apparatuses, are the flow routers and the DDoS attack may be prevented in at least one of the first and second routers 120 and 130. Since a configuration of the second router 130 is the same as that of the first router 120, a detailed description thereof will be omitted.

When at least one of the abnormal packet (A-packet) and the correct packet (packet) is input from the first and second terminal devices A and C, the first router 120 may determine whether at least one of the abnormal packet (A-packet) and the correct packet (packet), which are input, is a DDoS and transmit the correct packet (packet) to the second router 130.

In this case, when the correct packet (C-packet), which does not correspond to the DDoS attack, is input from the first router 120, the second router 130 transmits the correct packet (C-packet) to the security server 140.

Thereafter, the security server 140 may perform security check once again by applying a security program to the correct packet (C-packet) and thereafter, transmit the correct packet (C-packet) to the service server SV, and receive a service packet (not illustrated) corresponding to the correct packet (C-packet) to transmit the received service packet to the second terminal device C.

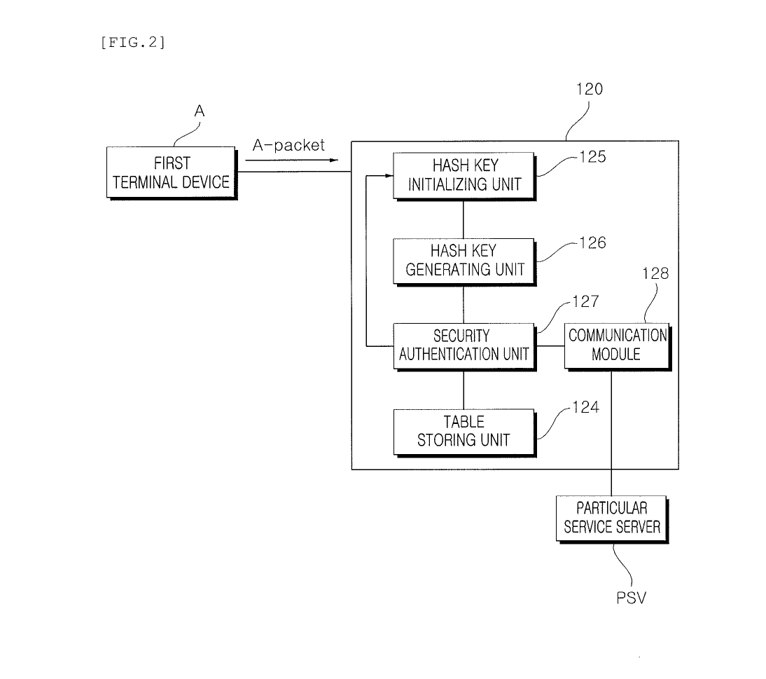

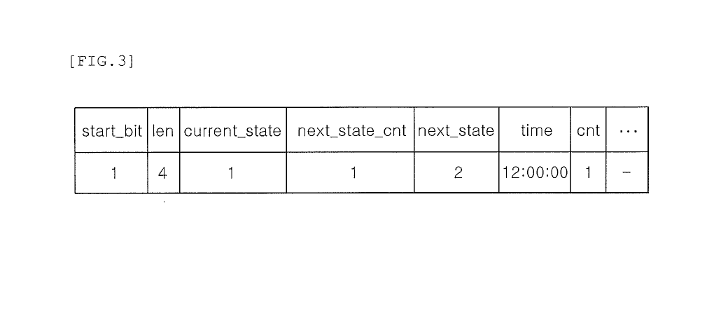

FIG. 2 is a control block diagram illustrating a control configuration of the network apparatus according to the exemplary embodiment of the present invention. FIG. 3 is a diagram illustrating an entry field illustrating pseudo state information.

FIG. 2 will be described based on the first router 120, and the second router 130 may be the same flow router or routing router as the first router 120. The present invention is not limited thereto.

Referring to FIG. 2, when at least one of the abnormal packet (A-packet) and the correct packet (C-packet) is input from at least one of the first and second terminal devices A and C, the first router 120 may include a security authentication module 122 that executes security authentication of the DDoS attack and a communication module 128 that transmits at least one of the abnormal packet (A-packet) and the correct packet (C-packet) authenticated by the security authentication module 122 to a particular service server PSV when requesting access to the specific server PSV set based on 5 tuples included in the input packet.

In the exemplary embodiment, the security authentication module 122 authenticates that the abnormal packet (A-packet) transmitted from the first terminal device A is the DDoS attack and the correct packet (C-packet) transmitted from the second terminal device C is not the DDoS attack.

First, the abnormal packet (A-packet) is transmitted from the first terminal device A to the security authentication module 122.

That is, the security authentication module 122 may include a table storing unit 124 that includes a flow hash table in which previous flow information on a previously input packet is stored in a hash packet and a routing table including next hop information, a hash key initializing unit 125 that initializes a bidirectional hash key set in the pseudo state at the time of inputting the abnormal packet (A-packet), a hash key generating unit 126 that generates a predetermined hash key based on the 5 tuples included in the abnormal packet (A-packet), and a security authentication unit 127 that determines a request for access to a particular service server PSV or not and determines the DDoS attack or not by executing the security authentication based on predetermined flow information when the predetermined flow information is stored in a predetermined hash bucket corresponding to the predetermined hash key, based on the 5 tuples.

Herein, the flow table stored in the table storing unit 124 includes flow information of the input abnormal packet (A-packet) and a flow identifier which is a flow index and the flow information included in the flow table may include a destination address of the abnormal packet (A-packet).

That is, the flow information may include at least one of the next hop information, a hash value generated based on the hash key, and pseudo state information bitstream-calculated based on the hash value. When the abnormal packet (A-packet) is received, the flow information may be made by using information included in the hash bucket which is generated in a hardware ASIC memory in real time.

Herein, the pseudo state information may include at least one of a position where bit calculation starts, a bit length to be compared, a current state, a next state, a next state address, an input time, and the number of comparison times, and a detailed description thereof will be described below.

The routing table stored in the table storing unit 124 stores transmission route information up to a specific destination and may include, for example, an input interface field, a destination identifier field, a next hop field, and an output interface field.

Herein, the next hop field may represent a next destination address for transferring the abnormal packet (A-packet) to the destination.

The hash key initializing unit 125 may perform a procedure for security authentication by initializing the bidirectional hash key, which is set in advance, when the abnormal packet (A-packet) is input.

The hash key generating unit 126 may generate a predetermined hash key of the abnormal packet (A-packet) input by using the 5 tuples including at least one of an IP source address, a destination address, a source port, a destination port, and a protocol type.

In this case, the predetermined hash key may generate the hash value by using a hashing function and the hash value may represent the hash bucket of the flow hash table storing predetermined flow information for the abnormal packet (A-packet).

The security authentication unit 127 may execute security authentication when a final destination of at least one of the abnormal packet (A-packet) and the correct packet (C-packet) is a particular service server (PSV).

In the exemplary embodiment, the security authentication unit 127 executes security authentication for a packet that requests access to the particular service server (PSV), but the security authentication unit 127 may execute security authentication even when requesting access to another general service server (SV), and the present invention is not limited thereto.

In this case, the security authentication unit 127 may generate new flow information including new next hop information and set pseudo state information, which is previously set and security-authenticated, in the routing table, when predetermined flow information is not stored in a predetermined hash bucket corresponding to the predetermined hash key, stores the new flow information in a new hash bucket of the flow table, and transmits the abnormal packet (A-packet) or the correct packet (C-packet) through the communication module 128.

The security authentication unit 127 compares a predetermined next state address and a previous next state address among predetermined pseudo state information included in predetermined flow information, when the predetermined flow information corresponding to the abnormal packet (A-packet) is stored, thereby performing security authentication.

The entry field for the predetermined pseudo state information will be described below with reference to FIG. 3.

That is, the pseudo state information may include at least one of a position (start_bit, 1) where bit calculation starts, a bit length (len, 4) to be compared, a current state (current_state, 3), a next state (next_state_cnt, 4), a next state address (next_state, 5), an input time (time, 6), and the number of comparison times (cnt, 7), as described above.

Herein, the pseudo state information is generated based on the 5 tuples and the hash value or the hash key included in the abnormal packet (A-packet) and a content on the next state address (next_state, 5) may be used in order to decide whether the abnormal packet (A-packet) is the DDoS attack.

That is, the security authentication unit 127 may decide whether the abnormal packet is the DDoS attack according to the next state address (next_state, 5) among pseudo state information included in predetermined flow information when predetermined flow information on the abnormal packet (A-packet) is stored.

The security authentication unit 127 may generate flow information based on the set pseudo state information and the routing table and transmit the generated flow information to a particular service server (PSV) when the predetermined flow information on the abnormal packet (A-packet) is not stored.

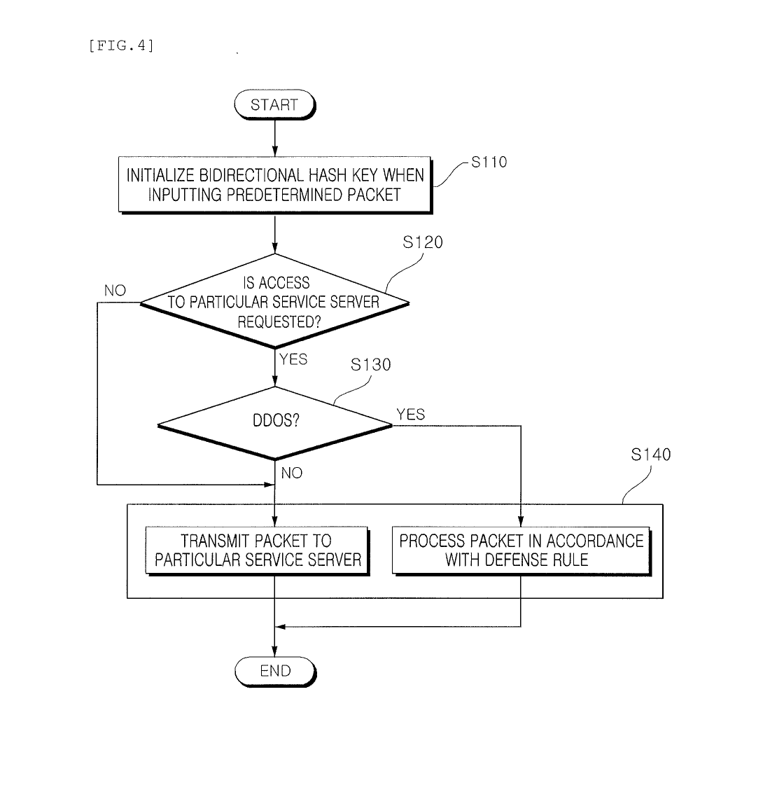

FIG. 4 is a flowchart illustrating an operating method of a network apparatus according to an exemplary embodiment of the present invention.

Referring to FIG. 4, a bidirectional hash key is initialized at the time of inputting a predetermined packet (S110) and it is determined whether access to a particular service server where the predetermined packet is set is requested (S120).

That is, when an abnormal packet (A-packet) transmitted from a first terminal device A is input, a first router 120 initializes the bidirectional hash key in a pseudo state at the time of inputting the abnormal packet (A-packet) and determines whether the access to a particular service server PSV set based on five tuples included in the abnormal packet (A-packet) is requested.

In step S110, when the predetermined packet requests the access to the particular service server, security authentication for a DDoS attack is executed (S130).

That is, when it is determined that the abnormal packet (A-packet) requests the access to the particular service server (PSV), the first router 120 executes security authentication of the DDoS attack.

The predetermined packet security-authenticated in step S130 is transmitted to the particular service server (S140).

That is, when it is determined that the abnormal packet (A-packet) is the DDoS attack through the security authentication, the first router 120 processes the abnormal packet (A-packet) in accordance with a set defense rule, and when the abnormal packet (A-packet) is not the DDoS attack through the security authentication, the first router 120 transmits the abnormal packet (A-packet) to the second router 130 or the particular service server (PSV) through the communication module 128.

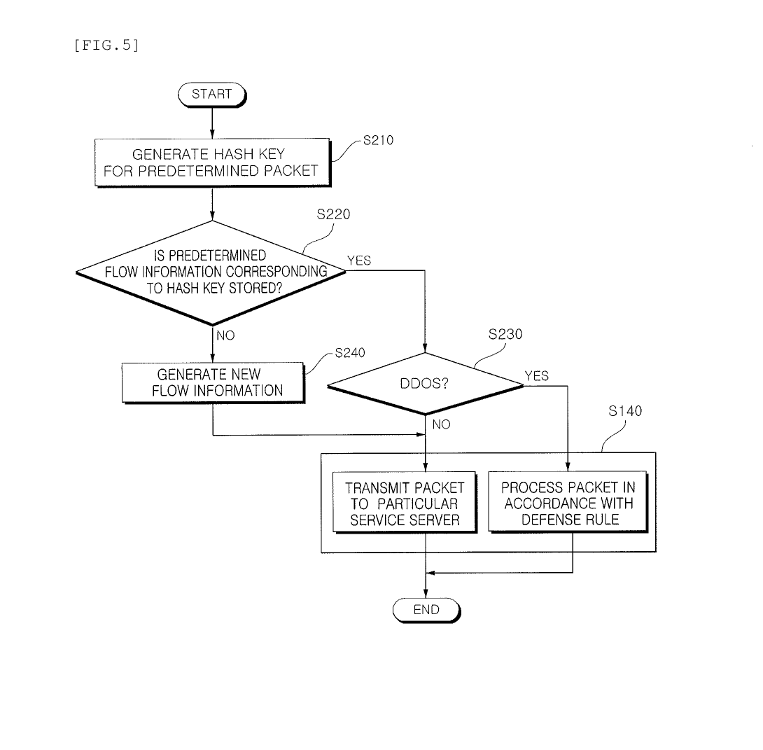

FIG. 5 is a flowchart for security authentication illustrated in FIG. 4.

Referring to FIG. 5, a predetermined hash key is generated based on 5 tuples included in a predetermined packet (S210) and it is determined whether to store predetermined flow information stored in a hash bucket corresponding to a hash key in a flow hash table (S220).

That is, a first router 120 generates a predetermined hash key based on 5 tuples included in an abnormal packet (A-packet), calculates a hash value based on the predetermined hash key and thereafter, verifies whether there is the hash bucket stored in the flow hash table and corresponding to the hash value to determine whether the predetermined flow information is stored in the hash bucket.

When it is determined that the predetermined flow information is stored in step S220, it is determined whether the predetermined packet is a DDoS attack based on pseudo state information included in the predetermined flow information (S230), and when the predetermined packet is the DDoS attack, the predetermined packet is processed in accordance with a set method rule, and when the predetermined packet is not the DDoS attack, step S130 is executed.

That is, the first router 120 may determine the DDoS attack in accordance with a next state address (next_state, 5) among the pseudo state information included in the predetermined flow information corresponding to the abnormal packet (A-packet).

When it is determined that the predetermined flow information is not stored in step S220, the predetermined flow information is generated and step S130 is executed (S240).

That is, when it is determined that the predetermined flow information is not stored, the first router 120 generates new flow information including new next hop information and set pseudo state information, which is previously set and security-authenticated, in a routing table, thereby storing the generated flow information in a new hash bucket of the flow hash table.

The first router 120 may transmit the abnormal packet (A-packet) to the particular service server (PSV).

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A network apparatus, comprising:
a security authentication module that executes security authentication of a distributed denial of service (DDoS) attack when a predetermined packet requests access to a particular service server to which the security authentication is applied, at the time of inputting the predetermined packet; and
a communication module that transmits the predetermined packet security-authenticated by the security authentication module through a transmission route of the particular service server.

2. The network apparatus of claim 1, wherein:
the security authentication module includes:
a hash key generating unit that generates a predetermined hash key based on tuple information included in the predetermined packet; and
a security authentication unit that determines a request for access to the particular service server or not based on the tuple information and decides the DDoS attack or not by executing the security authentication based on predetermined flow information corresponding to the predetermined hash key.

3. The network apparatus of claim 2, wherein:
the security authentication module includesa table storing unit that includes a flow hash table in which previous flow information on a previously input packet is stored in a hash bucket and a routing table including next hop information.

4. The network apparatus of claim 2, wherein the security authentication module includes a hash key initializing unit that initializes a bidirectional hash key set in a pseudo state at the time of inputting the predetermined packet.

5. The network apparatus of claim 3, wherein the next hop information includes a next destination address on the transmission route.

6. The network apparatus of claim 3, wherein the flow information includes at least one of next hop information, a hash value generated based on a hash key, and pseudo state information bitstream-calculated based on the hash value.

7. The network apparatus of claim 4, wherein the pseudo state information includes at least one of a position where bit calculation starts, a bit length to be compared, a current state, a next state, a next state address, an input time, and the number of comparison times.

8. The network apparatus of claim 2, wherein the tuple information includes at least one of an IP source address, a destination address, a source port, a destination port, and a protocol type.

9. The network apparatus of claim 2, wherein the security authentication unit generates new flow information including new next hop information and set pseudo state information, which is previously set and security-authenticated, in the routing table when predetermined flow information is not stored in a predetermined hash bucket corresponding to the predetermined hash key, stores the new flow information in a new hash bucket of the flow table, and transmits the relevant information to the communication module.

10. The network apparatus of claim 9, wherein the security authentication unit compares a predetermined next state address and a previous next state address among the predetermined pseudo state information to perform the security authentication.

11. An operating method of a network apparatus, comprising:
determining whether access to a particular service server set based on 5 tuples included in a predetermined packet is requested, at the time of inputting the predetermined packet;
executing security authentication of a distributed denial of service (DDoS) when the access to the particular service server is requested; and
transmitting the predetermined packet security-authenticated in the executing to the particular service server.

12. The method of claim 11, further comprising:
before the determining,
initializing a bidirectional hash key in a pseudo state at the time of inputting the predetermined packet.

13. The method of claim 11, further comprising:
before the determining,
generating a hash key based on the 5 tuples.

14. The method of claim 13, wherein:
the executing includes:
verifying whether there is a predetermined hash bucket storing predetermined flow information corresponding to the hash key in a flow hash table in which previous flow information on a previously input packet is stored in a hash bucket; and
deciding whether the predetermined packet is a DDoS attack by executing security authentication based on the predetermined flow information when the predetermined hash bucket is present and the predetermined flow information is stored.

15. The method of claim 14, wherein:
in the verifying,
when a predetermined hash bucket storing the predetermined flow information corresponding to the hash key is not present, new flow information including new next hop information and set pseudo state information, which is previously set and security-authenticated, in a routing table including next hop information is generated to be stored in a new hash bucket of the flow table and transmitted to the particular service server.

16. The method of claim 14, wherein:
in the determining,
when the predetermined flow information is stored, a predetermined next state address and a previous next state address among predetermined pseudo state information included in the predetermined flow information are compared to perform the security authentication.
